(19) United States
(12) Patent Application Publication
(10) Pub. No.: US 2022/0193782 A1
(43) Pub. Date: Jun. 23, 2022

(54) MATERIAL DEPOSITION UNIT WITH MULTIPLE MATERIAL FOCAL ZONES, AND METHOD FOR BUILD-UP WELDING

(71) Applicant: TRUMPF Laser- und Systemtechnik GmbH, Ditzingen (DE)

(72) Inventors: Bjoern Sautter, Stuttgart (DE); Marco Opitz, Waldstetten (DE); Benedikt Wessinger, Kaempfelbach (DE); Timo Steeb, Leonberg (DE); Franziska Spitz, Holzgerlingen (DE)

(21) Appl. No.: 17/688,925

(22) Filed: Mar. 8, 2022

Related U.S. Application Data
(63) Continuation of application No. PCT/EP2020/071603, filed on Jul. 30, 2020.

(30) Foreign Application Priority Data
Sep. 12, 2019 (DE) 10 2019 124 518.4

(51) Int. Cl. B22F 12/55; B33Y 10/00; B33Y 30/00; B22F 10/28; B22F 12/53; B23K 26/144; B23K 26/342; B23K 26/14

(52) U.S. Cl. CPC B22F 12/55; B33Y 10/00; B33Y 30/00; B23K 26/1464; B22F 12/53; B23K 26/144; B23K 26/342; B22F 10/28

(57) ABSTRACT

A material deposition unit includes a radiation unit configured to emit electromagnetic radiation in a directed manner onto a workpiece along a beam axis extending in a beam direction and, and a powder discharge device having multiple powder discharge units configured to discharge powder in a directed form onto the workpiece. The powder discharge device includes at least a first powder discharge unit and a second powder discharge unit. The first powder discharge unit has a plurality of first powder-outlet openings with a first material focal zone. The second powder discharge unit has a plurality of second powder-outlet openings with a second material focal zone. The first material focal zone and the second material focal zone being spaced apart from one another in the beam direction.

### CROSS REFERENCE TO RELATED APPLICATIONS

This application is a continuation of PCT International Application No. PCT/EP2020/071603 (WO 2021/047821 A1), filed on Jul. 30, 2020, and claims benefit to German Patent Application No. DE 10 2019 124 518.4, filed on Sep. 12, 2019. The aforementioned applications are hereby incorporated by reference herein.

### FIELD

The present invention relates to a generative manufacturing method for metallic structures, such as laser build-up welding (also Laser Metal Deposition (LMD), Direct Metal Deposition (DMD) or Direct Energy Deposition (DED)).

### BACKGROUND

In principle, laser build-up welding is carried out as follows: On a component surface, by means of a laser a melt pool is created or a base material forming the component surface is heated. When reference is made to “melt pool” below, what is also meant by this is a general process zone which comprises a heated or molten base material. The melt pool can for example melt a few micrometers of the base material, but greater melting depths are also conventional. Metal powder is introduced in an automated manner by means of a powder discharge device, usually in the form of a nozzle. The result is beads or material layers which are welded to one another and produce structures on existing or new basic bodies or components.

(Laser) build-up welding makes it possible for example to apply 3D structures to existing or new, possibly also uneven, surfaces. Geometry modifications can be easily implemented in this way. By modifying the powder and/or the powder composition, it is possible to switch between various materials in one work process. It is also possible to blend the powder used from different materials and thereby to create alloys. To provide wear-resistant layers, it is for example possible to feed a matrix material in powder form which melts in the melt pool and in addition to feed a hard material, which typically does not melt at the temperatures prevailing in the melt pool, likewise in powder form.

During laser build-up welding, it is conventional to use a material deposition unit having a laser unit which is configured to direct a laser beam onto a workpiece, and having a powder discharge device which is configured to discharge powder in a directed form onto the workpiece.

In this context, the powder discharge device is conventionally designed in such a way that it discharges the material powder in the direction of the workpiece via an annular die or multiple powder discharge units, which may be in the form of powder-outlet openings, for example. This results in one powder jet or a plurality of powder jets. These powder jets are focused in a material focal zone. In this context, the existing systems are sensitive to the spacing of the powder discharge device and the powder focal position from the workpiece and to the combination of angle of contact (angle at which the laser beam is directed onto the workpiece), spacing and diameter of the material focus.

### SUMMARY

Embodiments of the present invention provide a material deposition unit that includes a radiation unit configured to emit electromagnetic radiation in a directed manner onto a workpiece along a beam axis extending in a beam direction and, and a powder discharge device having multiple powder discharge units configured to discharge powder in a directed form onto the workpiece. The powder discharge device includes at least a first powder discharge unit and a second powder discharge unit. The first powder discharge unit has a plurality of first powder-outlet openings with a first material focal zone. The second powder discharge unit has a plurality of second powder-outlet openings with a second material focal zone. The first material focal zone and the second material focal zone being spaced apart from one another in the beam direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a material deposition unit according to the invention, during irradiation of a workpiece;

FIG. 2 shows a material deposition unit according to the invention, during irradiation of a workpiece with focal zones lying above the workpiece;

FIG. 3 shows an arrangement according to the invention of powder-outlet openings with different powder feed angles;

FIG. 4 shows a material deposition unit having two different types of powder-outlet openings with the same powder feed angle;

FIG. 5 shows a material deposition unit having two material-outlet openings arranged in different planes;

FIG. 6 shows a material deposition unit having a powder division unit; and

FIG. 7 shows a material deposition unit having two powder division units.

### DETAILED DESCRIPTION

An object of the present invention is now to provide a material deposition unit and a method for laser build-up welding that are particularly flexible and allow the process to be carried out robustly. Said object is achieved by a material deposition unit as claimed in claim 1 and a method for laser build-up welding as claimed in claim 11. Further configurations of the invention are specified in the dependent claims and in the following description.

Consequently, the material deposition unit according to the invention includes: A radiation unit designed to emit electromagnetic radiation in a directed manner, in particular a laser unit, and a powder discharge device. The radiation unit, in particular laser unit, is configured to direct electromagnetic radiation, in particular a laser beam, onto a workpiece along a beam axis extending in a beam direction, in particular to focus it there (it may also be provided that defocusing is effected at the workpiece). On the workpiece, the radiation, in particular the laser beam impinging there, in particular focused there, creates a weld pool or a melt pool. The powder discharge device is configured to discharge a material powder, which typically is or comprises a metallic or ceramic powder, onto the workpiece. Typically, this is realized by a powder/gas jet. In this respect, the powder discharge device comprises multiple powder discharge units, which are configured to discharge the powder in a directed form (for example in the form of a jet or multiple jets) onto the workpiece. According to the invention, the material deposition unit is distinguished in that the powder discharge device comprises at least a first powder discharge unit and a second powder discharge unit, which are each configured in such a way that they focus the material powder they discharge at a first and second material focal zone, respectively.

In this context, the first and the second material focal zone are arranged spaced apart from one another in the beam direction. In other words, the regions in which the powder jets discharged by the powder discharge units are brought together in a focused manner (that is to say the material focal zones of the individual powder discharge units) are spaced apart from one another in the direction in which the laser beam is directed onto the workpiece. Typically, in this respect the material focal zones fall on the beam axis.

According to the invention, it may also furthermore be provided that the powder discharge device comprises further powder discharge units, each of which is configured in such a way that it focuses the material powder it discharges at a respective further material focal zone. These further material focal zones may in turn be arranged spaced apart with respect to the first and the second material focal zone in the beam direction.

Typically, it is also provided that each of the powder discharge units has a plurality of powder-outlet openings. Correspondingly, the first powder discharge unit typically has a plurality of first powder-outlet openings, in particular at least three of them. The second powder discharge unit typically has a plurality of second powder-outlet openings, in particular at least three of them.

The individual powder jets from the powder-outlet openings are brought together or focused in the respective material focal zone. The individual powder jets thus impinge on one another in this zone. The powder discharge units or the respective powder-outlet openings are correspondingly arranged and configured to that end. In other words, they are configured such that they discharge the powder jets in a correspondingly directed manner.

Typically, it may be provided that the plurality of first powder-outlet openings and the plurality of second powder-outlet openings each comprise the same number of respective powder-outlet openings. This makes it possible in particular to easily ensure that the same amount of material is focused in each of the two material focal zones. Moreover, directionally independent material focal zones can be provided in a simple manner in terms of construction in this way.

According to the invention, it may also be provided that the first powder-outlet openings are configured to discharge a respective powder jet at a first powder feed angle relative to the beam axis in the direction of the first material focal zone, and correspondingly the second powder-outlet openings are configured to discharge a respective powder jet at a second powder feed angle relative to the beam axis in the direction of the second material focal zone. In this context, the first powder feed angle and the second powder feed angle may be different. This makes it possible for example to provide an arrangement of material focal zones that is offset along the beam axis, though the powder-outlet openings of the first and the second type may be arranged at the same height and on the same hole circle diameter as seen along the beam axis.

The first and the second powder feed angle may, however, also be identical and the powder-outlet openings may nevertheless be arranged in the same plane along the beam axis, it being possible in that case to provide for example that, to realize the material focal zones that are spaced apart along the beam axis, the powder-outlet openings of the first and the second type (possibly of further types) are arranged spaced apart from the beam axis to different extents (the powder-outlet openings of the first and the second type and/or of further types may be arranged on different hole circle diameters). For example, the powder-outlet openings of the first type may be arranged on a first imaginary circle about the beam axis, and the powder-outlet openings of the second type may be arranged on a second imaginary circle about the beam axis. Typically, it may generally be provided that the powder-outlet openings of the first type all have the same powder feed angle, and the powder-outlet openings of the second type likewise all have the same powder feed angle (which may be different than the first).

It may in particular be provided that the first powder-outlet openings are arranged at a first spacing from the beam axis as seen in a viewing plane running orthogonally to the beam axis, and the second powder-outlet openings are arranged in this viewing plane at a second spacing, which is different than the first spacing, from the beam axis (further types may be arranged at further spacings that are in turn different). In this respect, the powder-outlet openings of the first and the second type may lie in the viewing plane as seen in the beam direction (that is to say, lie at the same “height” along the beam axis). Typically, the powder-outlet openings of the first type lie on a first imaginary circle about the beam axis, and the powder-outlet openings of the second type lie on a second imaginary circle about the beam axis.

It is also possible that, in the viewing plane, the powder-outlet openings of the two types are respectively arranged at the same spacing from the beam axis or are respectively arranged on the same imaginary circle about the beam axis. In this case, the powder-outlet openings may lie in the viewing plane. Typically, in this case the powder-outlet openings are designed in such a way that they have different powder feed angles.

It may also be provided that the powder-outlet openings of the first and the second type respectively lie in a first and a second plane running orthogonally to the beam axis, the two planes being arranged spaced apart from one another in the beam direction. In other words, it may be provided that the different types of powder-outlet openings are arranged at different heights along the beam axis in the beam direction.

A combination of the different possible ways of arranging the various types of powder-outlet openings may also be provided, for example at various spacings from the beam axis and with different powder feed angles. Possible within the meaning of the invention is for example also an arrangement in various planes and with different powder feed angles. Possible within the meaning of the invention is for example also an arrangement in various planes and at various spacings from the beam axis. Possible within the meaning of the invention is for example also an arrangement in various planes and at various spacings from the beam axis and with different powder feed angles.

It may also be provided that the material deposition unit comprises a powder division unit, which distributes a central powder stream uniformly between the various powder discharge units or uniformly between the various powder-outlet openings.

Typically, the material deposition unit is designed in such a way that the powder-outlet openings are arranged uniformly distributed about the beam axis in the circumferential direction. This results in particular in a preferred uniform build-up behavior of the material deposition unit. According to the invention, it may also be provided that the plurality of first powder-outlet openings is connected to a different powder source than the plurality of second powder-outlet openings. This is suitable in particular when different powder materials are to be applied in combination. For example, this makes it possible to combine a hard material with a matrix material, with the result that wear-resistant layers can be applied in an advantageous manner. In that case, the matrix material is preferably applied with a different material focus than the hard material particles.

As described above, the present invention also relates to a method for build-up welding, in particular laser build-up welding. In this method, electromagnetic radiation, in particular a laser beam, is directed, and in particular focused, onto a workpiece surface along a beam axis extending in the beam direction. The radiation, in particular the laser radiation or the focusing of the laser beam, creates a melt pool or heats the workpiece. A powder material is fed to the melt pool or to the heated workpiece surface via multiple powder jets. Now, the method according to the invention is distinguished in that a plurality of powder jets is focused in a first material focal zone and a second plurality of powder jets is focused in a second material focal zone, with the two material focal zones being arranged spaced apart from one another along the beam axis. As already set out in conjunction with the material deposition unit, it is also possible for further material focal zones at further spacings to be provided.

In a development according to the invention, it may be provided that a matrix material is fed to the melt pool or the heated impingement point via the first plurality of powder jets, whereupon this matrix material typically melts in the melt pool (or melts for example already in flight or on the way to the melt pool or to the heated impingement point, given the prevailing conditions there) and may be formed by a metallic material, for example. In this method variant, a hard material is fed to the melt pool via the second plurality of powder jets, and typically does not melt in the melt pool (or is selected such that the hard material particles do not melt, or do not melt by the time the melt pool has resolidified, given the prevailing conditions there). As a result, this method variant is suitable in particular for producing wear-resistant layers. Hard material particles may be melted in the melt pool or in the laser beam upstream of the workpiece. However, this is not obligatory. It may be provided that they are merely heated.

In an advantageous refinement of the method according to the invention, one of the material deposition units described in the present application is used to carry out the method.

Further features, possible applications and advantages of the invention will become apparent from the following description of exemplary embodiments of the invention, which will be discussed on the basis of the drawing, it being possible for the features to be essential to the invention both individually and in different combinations, without this being explicitly pointed out again. In the drawing:

In the following figures, corresponding components and elements bear the same reference signs. Variants of corresponding elements are further identified by letters; in this respect, a reference sign without letters refers to all such variants differentiated further by letters. For the sake of better clarity, all reference signs are not reproduced in all of the figures.

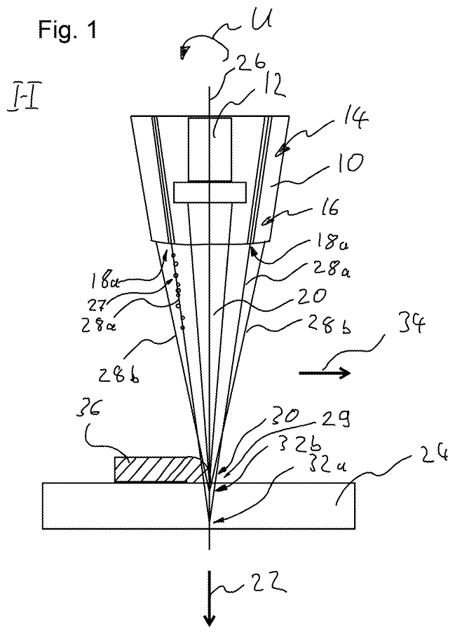

A material deposition unit as a whole bears the reference sign 10 in FIG. 1. The material deposition unit comprises firstly a laser unit 12 and a powder discharge device 14, the powder discharge device 14 comprising multiple powder discharge units 16, each of which in turn comprises multiple powder-outlet openings 18.

The laser unit 12, which constitutes an example of a radiation unit designed to emit electromagnetic radiation in a directed manner, is configured here in such a way that it directs a laser beam 20 onto a workpiece 24 in a beam direction 22. In the present case, the beam direction 22 is shown aligned perpendicularly to the workpiece surface. It may, however, also be guided at an angle of contact with the workpiece that is different than 90°. The beam direction 22 extends along a beam axis 26. The powder-outlet openings 18 are arranged about the beam axis 26. The powder discharge units 16 or powder-outlet openings 18 are each configured to discharge a powder 27 in the form of respective powder jets 28 in a directed form onto the workpiece 24. In this respect, what is provided in the present case is a plurality of first powder-outlet openings 18a and a plurality (not illustrated) of second powder-outlet openings 18b. First powder jets 28a emerge from the first powder-outlet openings 18a and second powder jets 28b emerge from the second powder-outlet openings 18b. The second powder-outlet openings 18b are arranged offset in relation to the first powder-outlet openings 18a in a circumferential direction U about the beam axis 26. Further types of powder-outlet openings 18 may be provided.

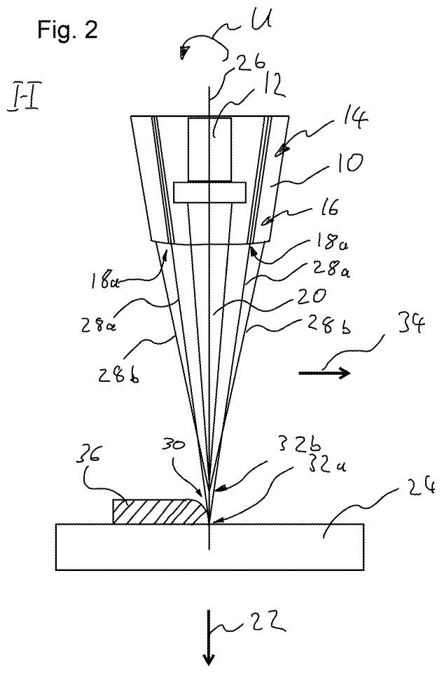

In the present case, the laser beam 20 is focused onto the workpiece 24 (the beam may also be defocused) and forms a process zone, which in the present case is in the form of a melt pool 30, on the workpiece 24 or on its surface 29 (reference is made below to a melt pool 30, but what is also meant by this is a heated portion of the workpiece surface; in general, the embodiments relate to a general process zone). The powder jets 28a and 28b or the powder 27 transported through them impinge(s) on the melt pool 30, powder jets 28a being focused in a first material focal zone 32a and the second powder jets 28b being focused in a second material focal zone 32b. Further material focal zones 32 spaced apart from the two material focal zones 32 shown are conceivable within the meaning of the invention. In this respect, in the present case the material focal zones 32 lie downstream of the melt pool 30 or the workpiece surface in the transport direction of the powder jets 28 (an arrangement upstream of the workpiece surface in the transport direction is also conceivable within the meaning of the invention; see FIG. 2. It is also possible for the material focal zones 32 to be arranged upstream and downstream of the workpiece surface). Since the laser beam is guided over the workpiece in a movement direction 34, the melt pool 30, which beforehand was melted and enriched by the powder material 27, solidifies and a built-up material layer 36 remains. It may also be provided that the material powder is heated (possibly melted) by the radiation prior to impinging on the workpiece and the heated powder adheres to the base material without melting it.

FIG. 2 shows a material deposition unit 10, which has a corresponding design to that of FIG. 1. In this case, however, the material focal zones 32 lie upstream of the process zone or the melt pool 30 or the workpiece surface in the transport direction of the powder jets 28.

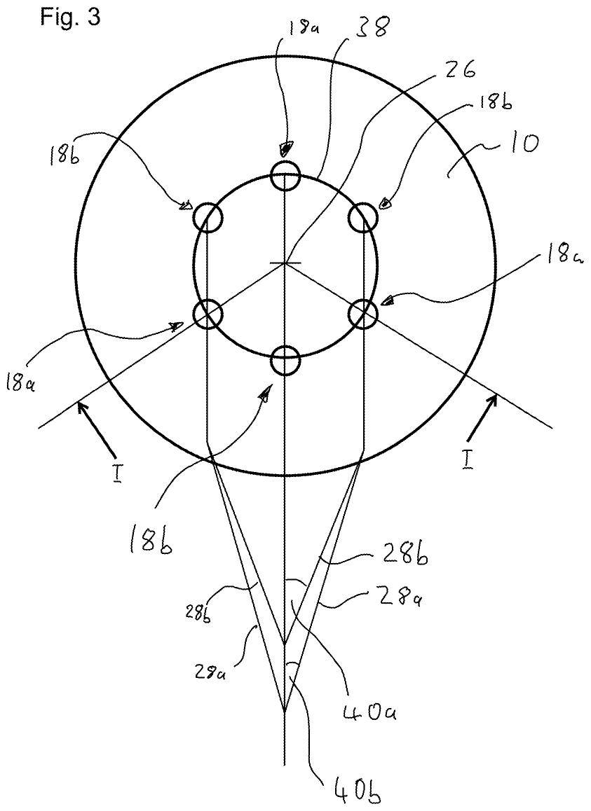

FIG. 3 schematically illustrates the material deposition unit 10 as seen from the workpiece along the beam axis 26.

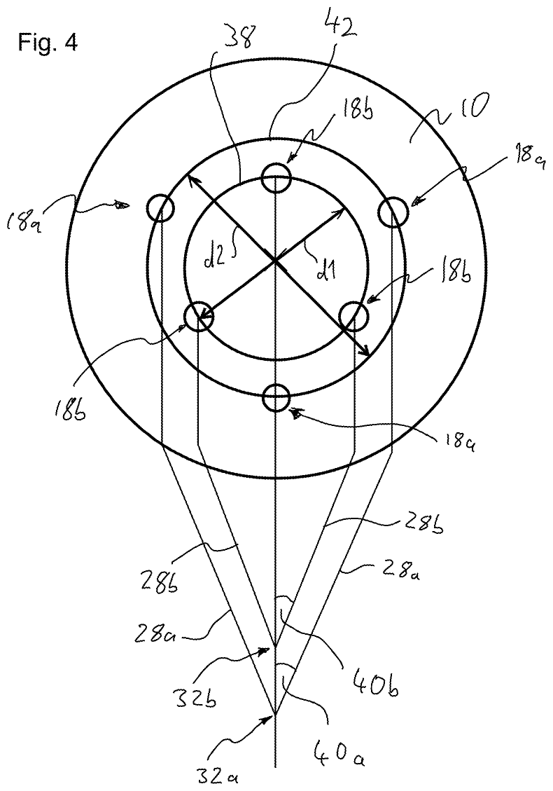

As can be seen in FIG. 3, in the present example the powder-outlet openings 18a of the first type and the powder-outlet openings 18b of the second type lie on a common imaginary circle 38 (here, the imaginary circle is arranged in a viewing plane 39 which extends orthogonally to the beam axis 26 and in which the powder-outlet openings 18 lie). An arrangement on different imaginary circles is likewise possible, as will also be explained in conjunction with FIG. 4. In this case, the powder-outlet openings 18 are configured in such a way that they have powder feed angles 40, with the powder feed angles 40a of the powder-outlet openings 18a of the first type and the powder feed angles 40b of the powder-outlet openings 18b of the second type being different. The different powder feed angles 40 result in material focal zones 32 that are arranged offset along the beam axis. Here, the powder feed angles 40 describe the angle at which the respective powder jets 28 emerging from the outlet openings 18 run in relation to the beam axis 26.

FIG. 4 shows an alternative material deposition unit 10, in which the outlet openings 18a and 18b of the first and the second type have the same powder feed angles 40a and 40b, respectively. However, in order to realize different material focal zones 32, the powder-outlet openings 18a of the first type and the powder-outlet openings 18b of the second type are arranged on different imaginary circles 38 and 42 about the beam axis 26. The powder-outlet openings 18a of the first type and the powder-outlet openings 18b of the second type may be arranged offset in relation to one another laterally or perpendicularly to the beam axis 26.

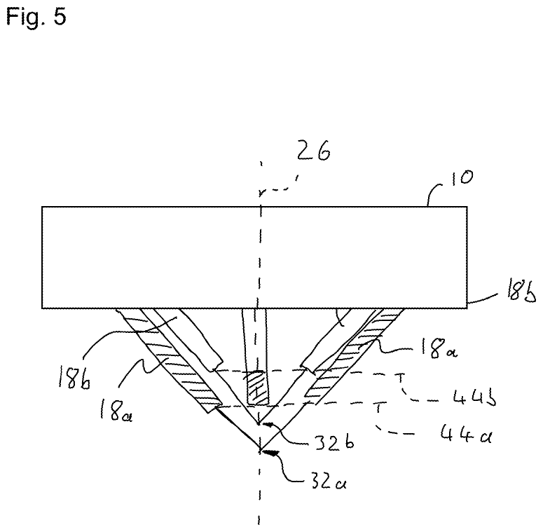

A design of a material deposition unit 10 as is shown in FIG. 5 is also possible. In the version of FIG. 5, the material-outlet openings are each arranged in two different planes 44 arranged offset in relation to one another toward the beam axis 26. The powder-outlet openings are only illustrated symbolically in this figure. FIG. 5 shows the material deposition unit 10 in a side view similar to that of FIG. 1 in this respect.

The possibilities described (FIG. 1 to FIG. 5) may also be provided in combination with one another in order to obtain an offset of the material focal zones 32.

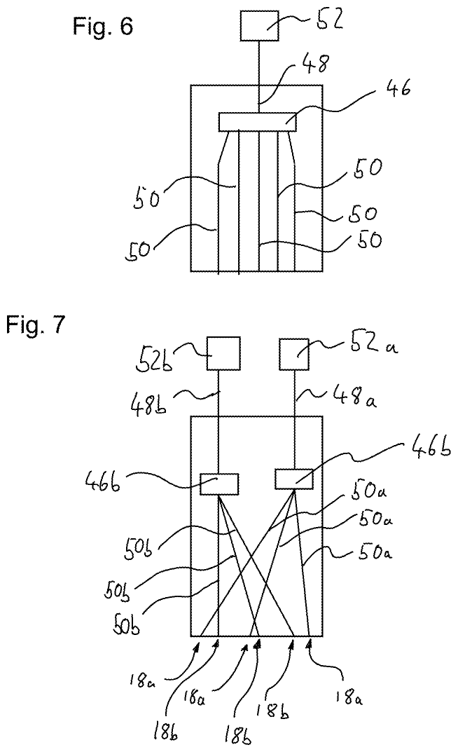

FIG. 6 shows a schematic material deposition unit 10, which comprises a powder division unit 46. The powder division unit 46 is designed to distribute a central powder stream 48 uniformly between the powder-outlet openings 18 (a non-uniform division is also conceivable). To this end, it divides the central powder stream 48 into corresponding partial streams. In this case, the central powder stream 48 is fed in the form of a powder/gas stream to the powder division unit 46 from a central powder source 52.

FIG. 7 shows a schematic material deposition unit 10, which comprises a first powder division unit 46a and a second powder division unit 46b. The powder division units 46 are designed to respectively distribute a first central powder stream 48a and a second central powder stream 48b uniformly (a non-uniform division is also conceivable) between the first and second powder-outlet openings 18a, 18b, respectively. To this end, they each divide the central powder streams 48a and 48b assigned to them into corresponding partial streams 50a and 50b, respectively, which in turn are fed to the corresponding first and second powder-outlet openings 18a and 18b. In this respect, the central powder streams 48 are each supplied by a central powder source 52a and 52b by means of a powder/gas stream. Here, the first powder source 52a provides a matrix material in powder form and the second powder source 52b provides a hard material. Correspondingly, the material deposition unit 10 shown in FIG. 7 is suitable in particular for producing wear-resistant layers. In the variant of FIG. 6, it is also conceivable for a blend of matrix material to be conducted to the powder-outlet openings 18 via the central powder source 52, in order to create wear-resistant layers or other layers.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A material deposition unit, comprising:
a radiation unit configured to emit electromagnetic radiation in a directed manner onto a workpiece along a beam axis extending in a beam direction and
a powder discharge device having multiple powder discharge units configured to discharge powder in a directed form onto the workpiece,
wherein the powder discharge device comprises at least:
a first powder discharge unit, which has a plurality of first powder-outlet openings, with a first material focal zone,
and a second powder discharge unit, which has a plurality of second powder-outlet openings, with a second material focal zone,
the first material focal zone and the second material focal zone being spaced apart from one another in the beam direction.

2. The material deposition unit as claimed in claim 1, the plurality of first powder-outlet openings and the plurality of second powder-outlet openings each comprising the same number of powder-outlet openings.

3. The material deposition unit as claimed in claim 1 each first powder-outlet opening being configured to discharge a respective powder jet at a first powder feed angle relative to the beam axis in the direction of the first material focal zone, and
each second powder-outlet opening being configured to discharge a respective powder jet at a second powder feed angle relative to the beam axis in the direction of the second material focal zone, with the first powder feed angle and the second powder feed angle being different.

4. The material deposition unit as claimed in claim 1, each first powder-outlet opening being configured to discharge a respective powder jet at a first powder feed angle relative to the beam axis in the direction of the first material focal zone, and
each second powder-outlet opening being configured to discharge a respective powder jet at a second powder feed angle relative to the beam axis in the direction of the second material focal zone, with the first powder feed angle and the second powder feed angle being identical.

5. The material deposition unit as claimed in claim 1, the first powder-outlet openings being arranged at a first spacing from the beam axis as seen in a viewing plane running orthogonally to the beam axis, and the second powder-outlet openings being arranged in the viewing plane at a second spacing, which is different than the first spacing, from the beam axis, with the first powder-outlet openings and the second powder-outlet openings lying in the viewing plane as seen in the beam direction.

6. The material deposition unit as claimed in claim 1, each of the first powder-outlet openings and the second powder-outlet openings being arranged at a same spacing as seen in a viewing plane running orthogonally to the beam axis, with the first powder-outlet openings and the second powder-outlet openings lying in the viewing plane as seen in the beam direction.

7. The material deposition unit as claimed in claim 1, the first powder-outlet openings lying in a first plane running orthogonally to the beam axis, and the second powder-outlet openings lying in a second plane, which runs orthogonally to the beam axis and is arranged spaced apart from the first plane in the beam direction.

8. The material deposition unit as claimed in claim 1, the material deposition unit comprising a powder division unit, which is designed to distribute a central powder stream uniformly between the powder discharge units, between the powder-outlet openings.

9. The material deposition unit as claimed in claim 1, the powder-outlet openings being arranged uniformly distributed about the beam axis in the circumferential direction.

10. The material deposition unit as claimed in claim 1, the plurality of first powder-outlet openings being connected to a different powder source than the plurality of second powder-outlet openings.

11. The material deposition unit as claimed in claim 1 the radiation unit comprising a laser unit configured to emit a laser beam onto the workpiece.

12. A method for laser build-up welding, comprising the steps of:
directing, using a laser unit, a laser beam onto a workpiece surface along a beam axis extending in a beam direction;
feeding a powder material to a process zone via a plurality first power jets and a plurality of second power jets, wherein the plurality of first powder jets is focused in in a first material focal zone, and the plurality of second powder jets is focused in a second material focal zone, the first material focal zone and the second material focal zone being spaced apart from each other along the beam axis.

13. The method as claimed in claim 12, the laser beam is focused onto the workpiece surface, in order to heat or melt a base material in a process zone.

14. The method as claimed in claim 13, wherein the process zone comprises a melt pool.

15. The method as claimed in claim 12, wherein a first material is fed to the process zone, via the plurality of first powder jets, and a second material different than the first material is fed to the process zone via the plurality of second powder jets.

16. The method as claimed in claim 15, wherein the first material comprises a matrix material, and the second material comprises a hard material.
